(19) United States
(12) Patent Application Publication
(10) Pub. No.: US 2015/0120518 A1
(43) Pub. Date: Apr. 30, 2015

(54) AUTHENTICATION AND PAYMENT SYSTEM

(71) Applicant: Invoice Cloud Incorporated, Braintree, MA (US)

(72) Inventors: Robert Bennett, Boston, MA (US); Robert Lapides, Walpole, MA (US); John Morabito, Vienna, VA (US); Kelton Averyt, Rancho Viejo, TX (US); Antonio Cordova, Braintree, MA (US)

(21) Appl. No.: 14/069,034

(22) Filed: Oct. 31, 2013

(51) Int. Cl. G06Q 20/14; G06Q 40/00

(52) U.S. Cl. CPC G06Q 20/14; G06Q 40/12
USPC 705/30; 705/40

(57) ABSTRACT

A a method includes authenticating one or more customers of each of multiple billers based on information received from each customer and identifying one or more accounts of each customer. The identified accounts of each customer are provided by the biller for the customer. The method includes enabling each authenticated customer to interact with (i) a biller system associated with the biller for the customer, the biller system providing a first type of service for the identified accounts of the customer, and (ii) a payment system associated with the multiple billers, the payment system providing a second type of service for the identified accounts of the customer.

### RELATED APPLICATIONS

This application is related to U.S. patent application Ser. No. 13/890,792 filed on May 9, 2013, entitled “ELECTRONIC INVOICING AND PAYMENT” and U.S. application Ser. No. 13/097,888, filed Apr. 29, 2011, entitled “ELECTRONIC INVOICE PRESENTATION AND PAYMENT SYSTEM”, all of which are incorporated here by reference.

### BACKGROUND

Before the advent of computers, when an entity, such as a landlord or a municipality, would present a bill to an individual or another entity, this bill was generally in paper form and would be hand delivered or mailed to the payer. In most instances, the payer would directly pay the bill by presenting the biller with cash or a check. Alternatively, if the biller was a merchant, the payer could present a credit card to the merchant. The credit card issuing company would then present a bill to the payer which would generally be paid by a check.

The utilization of computers and emails has changed the method in which payments can be made between the biller and the payer. The biller can establish an automated system between the payer and the payer's banking institution which will automatically deduct the payment from the payer's account. Additionally, computer systems would allow for the payment between the payer and the biller utilizing an electronic check. This payment process can be inefficient, particularly when multiple payments or invoices are due.

### SUMMARY

We describe here an authentication and payment system that provides authentication and billing services on behalf of multiple, independent billers and that provides payment services to customers of those billers. A customer of a biller can be authenticated by the authentication and payment system to seamlessly access a variety of account maintenance services and payment services for one or more accounts the customer has with the biller. Account maintenance services, such as updating contact information; starting, stopping, or transferring utility service; creating a work order; or other account maintenance services, or a combination of any two or more of them, are administered by each biller. Payment services, such as making or scheduling a payment, setting up an automatic payment schedule, enrolling in paperless billing, or other payment services, or a combination of any two or more of them, are administered by the authentication and payment system on behalf of each of multiple billers.

In a general aspect, a method includes authenticating one or more customers of each of multiple billers based on information received from each customer and identifying one or more accounts of each customer. The identified accounts of each customer are provided by the biller for the customer. The method includes enabling each authenticated customer to interact with (i) a biller system associated with the biller for the customer, the biller system providing a first type of service for the identified accounts of the customer, and (ii) a payment system associated with the multiple billers, the payment system providing a second type of service for the identified accounts of the customer.

In a general aspect, a computer readable medium stores instructions for causing a computing device to authenticate one or more customers of each of multiple billers based on information received from each customer and identify one or more accounts of each customer, the identified accounts of each customer provided by the biller for the customer. The instructions cause the computing system to enable each authenticated customer to interact with (i) a biller system associated with the biller for the customer, the biller system providing a first type of service for the identified accounts of the customer, and (ii) a payment system associated with the multiple billers, the payment system providing a second type of service for the identified accounts of the customer

Embodiments of one or both of these general aspects may include one or more of the following features.

Enabling an authenticated customer to interact with the payment system comprises providing a site associated with the payment system for display to the customer. In some cases, providing a site associated with the payment system for display to the customer includes providing the site associated with the payment system for display within a site associated with the biller system for the customer.

Enabling an authenticated customer to interact with the biller system and the payment system comprises enabling the customer to access information about one or more of the identified accounts of the customer through the biller system, the payment system, or both.

Enabling an authenticated customer to interact with the biller system and the payment system comprises enabling the customer to take an action associated with one or more of the identified accounts of the customer through the biller system, the payment system, or both.

The biller system provides account maintenance services, such as one or more of creating a work order, transferring a service, starting a service, stopping a service, and changing a contact information.

The payment system provides payment services, such as one or more of making a payment, scheduling a payment, setting up an automatic payment schedule, and enrolling in paperless billing.

Authenticating a particular customer comprises: receiving information from the particular customer; and comparing the received information to stored information for multiple customers. In some cases, the received information includes a customer identifier and a password.

Identifying one or more accounts for a particular customer comprises retrieving, from a database, one or more account identifiers associated with an identifier of the particular customer.

The biller system is associated with fewer than all of the multiple billers. In some cases, the biller system is associated with only the biller.

Enabling each authenticated customer to interact with the biller system and the payment system comprises providing access data to each authenticated customer. In some cases, the access data for each customer includes an identifier of each of the one or more accounts of the customer.

The method includes enabling each biller to specify one or more rules associated with an interaction between a customer of the biller and the payment system. In some cases, the one or more rules include rules associated with an appearance of a site of the payment system. In some cases, the one or more rules include a rule that indicates a relationship between a site of the payment system and a site of the biller system associated with the biller, such as a position of the site of the payment system within the site of the biller system. In some cases, the one or more rules include a rule indicative of a payment activity that is permitted, a rule indicative of a payment activity that is prohibited, or both.

In a general aspect, a method includes, for each of multiple billers, serving, by a first computing device associated with the multiple billers, a payment site for one or more accounts of a customer of the biller. The payment site is to be presented to the customer in association with a service site for the one or more accounts of the customer, the service site served by a second computing device associated with the biller.

In a general aspect, a computer readable medium stores instructions for causing a computing system to, for each of multiple billers, serve, by a first computing device associated with the multiple billers, a payment site for one or more accounts of a customer of the biller. The payment site is to be presented to the customer in association with a service site for the one or more accounts of the customer, the service site served by a second computing device associated with the biller.

Embodiments of one or both of these general aspects may include one or more of the following features.

The payment site is to be presented within a frame provided by the service site.

The method includes authenticating the customer of the biller. In some cases, authenticating the customer of the biller enables the customer to access the payment site and the service site.

The payment site provides payment services for the one or more accounts of the customer.

The service site provides account maintenance services for the one or more accounts of the customer.

These and other aspects, features, and implementations, and combinations of them, can be expressed as methods, apparatus, systems, components, software products, business methods, means and steps for performing functions, and in other ways. Other features and advantages will be apparent from the following description and from the claims.

### DESCRIPTION

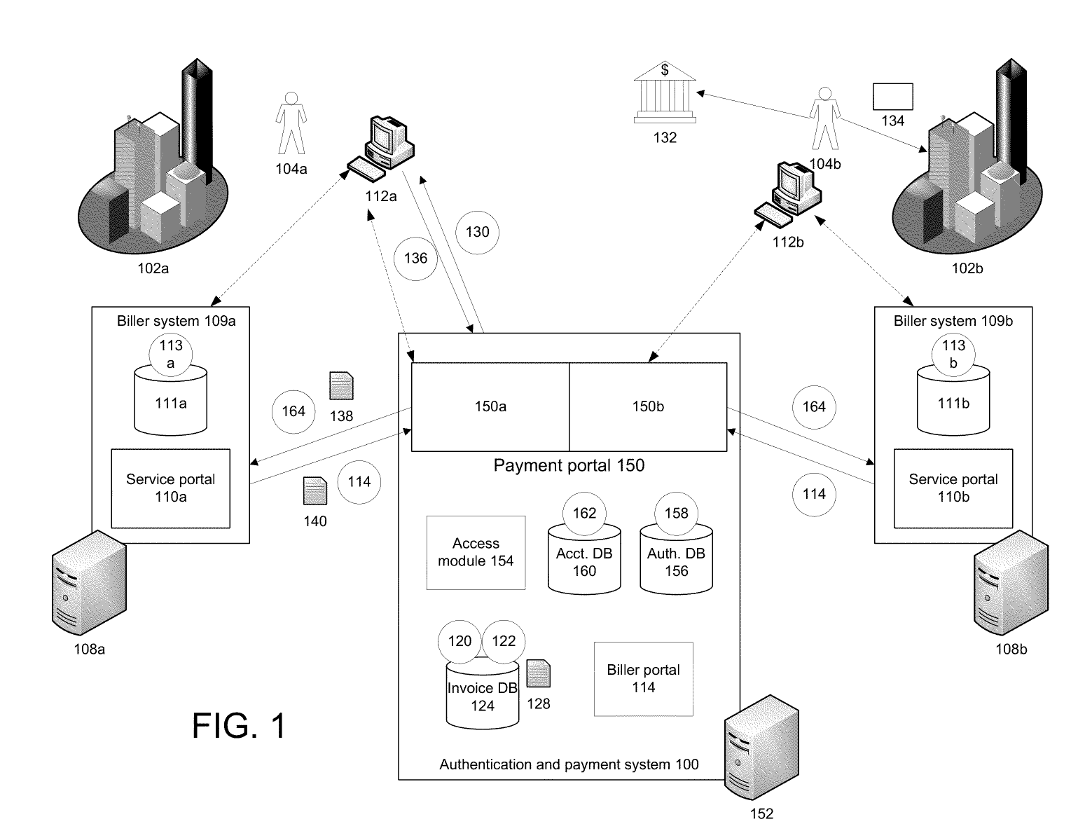

FIG. 1 is a system diagram.

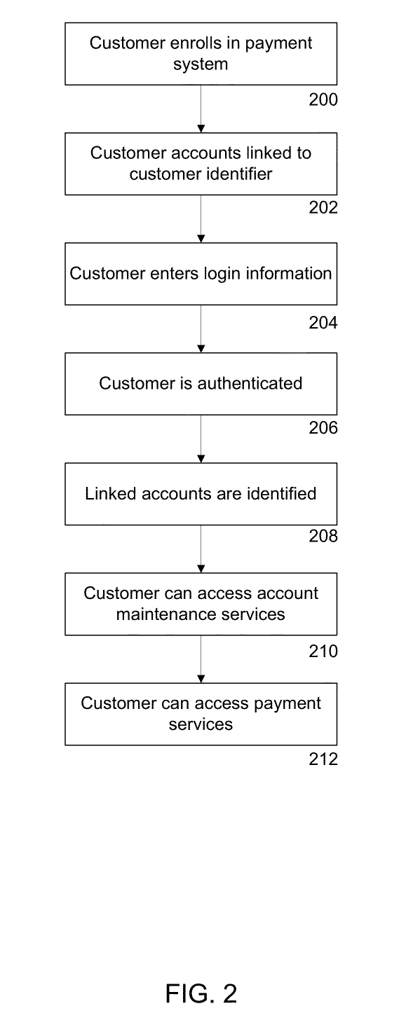

FIG. 2 is a flow chart.

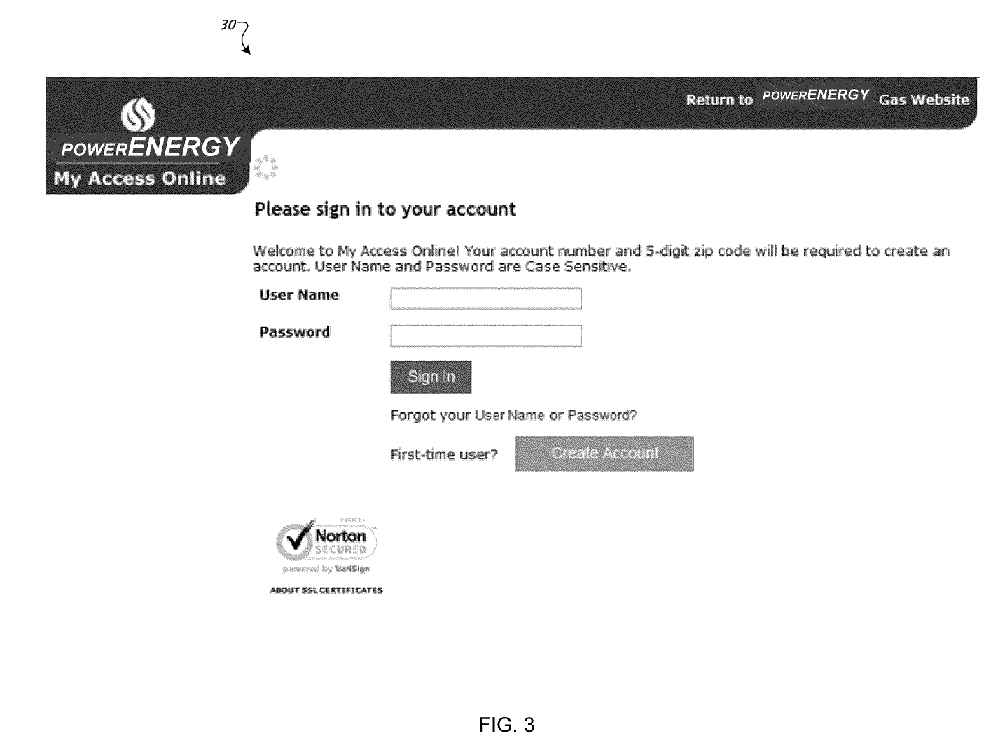

FIGS. 3-11 are screenshots.

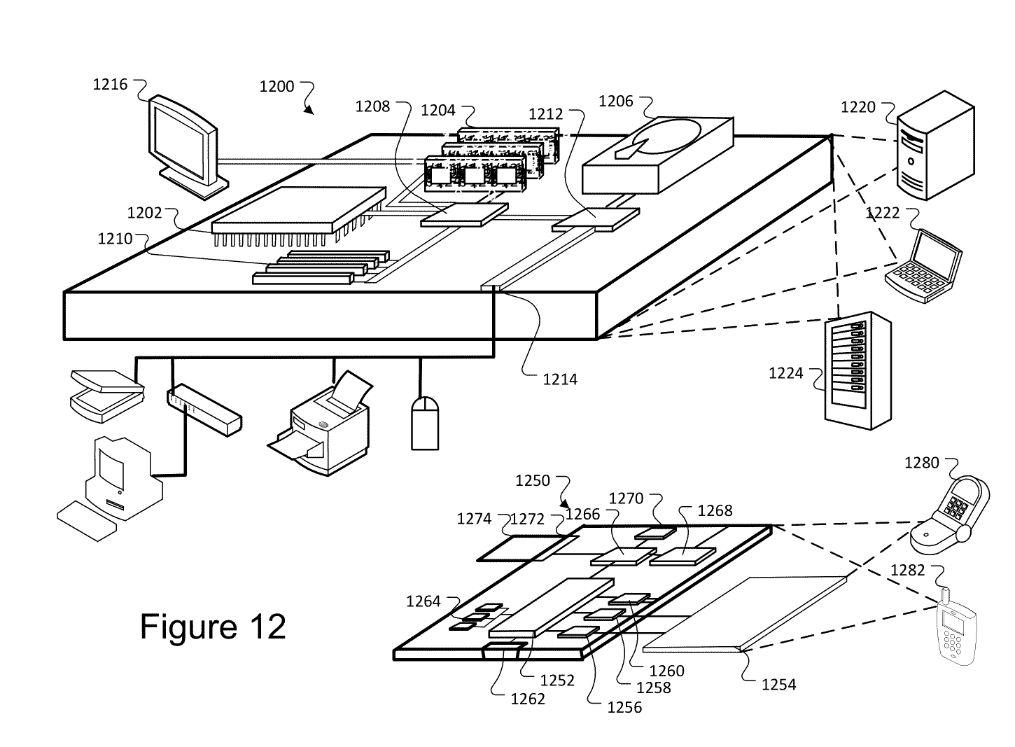

FIG. 12 is a system diagram.

We describe here an authentication and payment system that provides authentication and billing services on behalf of multiple, independent billers and that provides payment services to customers of those billers. A customer of a biller can be authenticated by the authentication and payment system to seamlessly access a variety of account maintenance services and payment services for one or more accounts the customer has with the biller. Account maintenance services, such as updating contact information; starting, stopping, or transferring utility service; creating a work order; or other account maintenance services, or a combination of any two or more of them, are administered by each biller. Payment services, such as making or scheduling a payment, setting up an automatic payment schedule, enrolling in paperless billing, or other payment services, or a combination of any two or more of them, are administered by the authentication and payment system on behalf of each of multiple billers.

A single login provides a customer with access to both account maintenance services provided by a biller for the customer's accounts with the biller and payment services provided by the authentication and payment system for the customer's accounts with the biller. This single login approach makes accessing these online services straightforward and convenient for customers, and thus can increase customer utilization of these services. From a biller perspective, greater customer participation can improve efficiency and save money, e.g., by reducing costs for the biller or increasing the likelihood that a customer will pay his bill. In addition, by allowing the authentication and payment system to handle authentication of customers, billers are spared the burdens and expense of complying with security standards for private customer data, such as Payment Card Industry (PCI) standards.

Referring to FIG. 1, an authentication and payment system 100 (which we also sometimes call a payment system) provides authentication and billing services on behalf of multiple independent, unrelated billers 102a, 102b (sometimes referred to collectively as billers 102). The payment system 100 also provides payment services to customers 104 of the billers 102. In the example of FIG. 1, customer 104a is a customer of both biller 102a and biller 102b and customer 104b is a customer of biller 102b.

By a biller, we mean broadly, for example, any entity that issues bills to its customers. For instance, a biller can be a utility company that issues electric bills and gas bills. A biller can be a city or town that issues several types of bills, such as water and sewer bills, real estate tax bills, and motor vehicle excise tax bills. A biller can be a property management company that issues rent bills and utility bills. By a bill we mean broadly, for example, any representation that is presented to a party in any form and refers to an amount due. By customers, we mean the people or entities that receive the bills, pay the bills, or both. For instance, customers of a city can include residents of the city, landlords who own property in the city, and businesses operating in the city. Customers of a property management company can include tenants in buildings operated by the property management company.

Each biller 102a, 102b is associated with a biller system 109a, 109b that provides a service portal 110a, 110b (e.g., a web site) through which customers 104 of the biller can access account maintenance services for one or more accounts the customer has with the biller. By account maintenance services, we mean services that are administered by the biller 102 and related to the maintenance of a customer's account with a biller 102. Example account maintenance services can include, e.g., creating a work order, viewing a utilization history, starting, stopping, or transferring a utility service, updating contact information, or other maintenance services, or a combination of any two or more of them. Data 113a, 113b about customer accounts, such as customer contact information, an address to which service is provided, an account history, or other data, or a combination of any two or more of them, is stored in an account database 111a, 111b and can be used to provide account maintenance services to customers. The account database 111a, 111b can be Each service portal 110a, 110b (sometimes referred to generally as service portals 110) can be accessed through a network connection, such as the Internet, between a computing device 112a, 112b used by one of the customer 104a, 104b and a server 108a, 108b hosting the respective service portal 110a, 110b.

In an example, the biller 102a may be the Atlantic Energy Company. Through the service portal 110a for the Atlantic Energy Company 102a, the customer 104a can log in to access account maintenance services for his electric or gas account. That is, with a single log in through the service portal 110a, the customer can gain access to account maintenance services for both of the accounts he has with the Atlantic Energy Company 102a. For instance, for one or both of the customer's accounts, the customer 104a can create a work order, view his electric or gas utilization history, order new service, cancel existing service, update his contact information, or other services, or a combination of any two or more of them.

In another example, the biller 102b may be the City of Boston. Through the service portal 110b for the City of Boston, the customer 104b can log in to access account maintenance services for various accounts the customer 104b has with the city 102b, such as a water account, a real estate tax account, a pet license account, a parking ticket account, a business license account, or other accounts, or a combination of any two or more of them. That is, with a single log in, the customer 104b can gain access to account maintenance services for multiple distinct accounts the customer 104b has with the biller 102b. Different services can be available for each type of account, as appropriate to the type of account. For instance, for a water account, the customer 104b can create a work order, view his water usage history, update his contact information, or access other services, or a combination of any two or more of them. For a real estate tax account, the customer 104 can view the assessed value of his property, update his contact information, or access other services, or a combination of any two or more of them.

Payment services for the customers' accounts are administered by the centralized payment system 100, which provides these payment services on behalf of multiple independent, unrelated billers 102. By payment services, we mean services that are administered by the payment system 100 and that support payments for a customer's account with a biller. Example payment services include, e.g., viewing an invoice, making a payment, scheduling a payment, setting up an automatic payment schedule, enrolling in paperless billing, or other payment services, or a combination of any two of them.

To allow customers 104 to access payment services, each service portal 110a, 110b is linked to a corresponding payment portal 150a, 150b (sometimes referred to generally as payment portals 150) hosted on a server 152 of the payment system. Each payment portal 150a, 150b provides payment services for one or more accounts the customer 104a, 104b has with the corresponding biller 102a, 102b. For instance, through the payment portal 150a of the payment system 100, the customer 104a can access payment services for his electric and gas accounts with the Atlantic Energy Company 102a. Similarly, through the payment portal 150b of the same payment system 100, the customer 104b can access payment services for his various accounts with the City of Boston 102b.

Customers 104 can access the payment portal 150 for a biller 102 through a link in the corresponding service portal 110. For instance, by logging in to the service portal 110 for a biller 102, a customer 104 can gain access to access to both account maintenance services (through the service portal 110) and payment services (through the payment portal 150) for one or more accounts the customer 104 has with the biller 102. That is, for instance, the customer 104 can seamlessly access both account maintenance services and payment services for multiple accounts without having to log in multiple times. To access account maintenance services, customers 104 access the service portal 110 through a direct connection between the computing device 112 and the biller's server 108. To access payment services, customers navigate to the payment portal 150 through the service portal 110 and then access the payment portal 150 through a direct connection between the computing device 112 and the server 152 hosting the payment system 100.

In some cases, although each payment portal 150 is hosted by the server 152 of the payment system 100 and not by the server 108 that hosts the service portal 110, the web site of the payment portal 150 can be presented to customers 104 as if it were part of the service portal 110, e.g., framed within the web site of the service portal 110. By framing the web site of the payment portal 150 within the web site of the service portal 110, it is not apparent to the customer 104 that he has left the service portal. Rather, the payment portal 150 appears to the customer 104 as if it were generated and hosted by the server 108 associated with the biller 102. This appearance helps to make customers 104 more comfortable interacting with the payment portal 150 and thus more likely to use the payment services offered through the payment portal.

Customers 104 can access various and flexible payment services through the payment portal 150. For instance, the customer can manage multiple, disparate or non-disparate bill types within a single visit to the payment portal 150. In one example, a customer can select three out of four open motor vehicle excise tax bills for payment in a single session with a single payment. In one example, a customer can select both a real estate tax bill and a water bill for payment in a single session with a single payment. Any applicable rules, such as convenience fees, rules regarding partial payments, or other types of rules (described in more detail below) that apply to one or more of the bills selected by the customer, can be applied automatically to the customer's selected bills while still allowing the bills to be paid together in a single transaction.

In order to enable this seamless access to both the service portal 110 that is administered by the biller 102 and the payment portal 150 that is administered by the payment system 100, customer authentication is handled at the payment system 100. When a customer 104 accesses a service portal 110, the customer 104 is prompted to log in to gain access to the customer's accounts. Although the login prompt appears as part of the service portal 110, the prompt is administered by the payment system 100 such that no customer authentication information (e.g., usernames or passwords) are handled by the service portal 110. To log in, the customer 104 enters login information 114, such as a username and a password. The login information 114 is transmitted directly to an access module 154 in the payment system 100.

The access module 154 authenticates the customer 104 based on the login information entered by the customer 104. By authenticate, we mean generally to confirm the identity of the customer 104. For instance, the access module 154 can access an authentication database 156 that stores login data 158, e.g., in a lookup table. The login data 158 can be the usernames and passwords for some or all of the customers 104 who have enrolled with the payment system 100. The access module 154 compares the login information 114 entered by the customer 104 with the login data 158 in the authentication database 156. If the login information 114 matches an entry in the authentication database 156, the customer 104 is authenticated. The authentication database 156 can be encrypted to secure the login data 158, e.g., according to Payment Card Industry (PCI) standards or another security standard.

PCI standards require that only organizations that are included in the overall scope of a PCI compliance burden be allowed to store customer authentication or payment data, such as usernames, passwords, credit card numbers, expiration data, or other data, or a combination of any two or more of them. That is, if the server 108 associated with a biller 102 and the server 152 of the payment system 100 both stored customer authentication or payment data, then the scope of a PCI burden and audit would have to encompass both the biller's server 108 and the payment system's server 152. By moving the responsibility for customer authentication and payment to the server 152 of the payment system 100, the payment system becomes the central clearinghouse for sensitive personal information for customers. The burden of PCI compliance is thus removed from the biller and shifted entirely to the payment system, making the approach to centralized authentication and payment described here attractive to billers.

Once the customer 104 has been authenticated, the access module 154 identifies one or more accounts that are associated with the customer 104. For instance, the access module 154 can access an account database 160 that stores account data 162. The account data 162 can include customer identifiers (e.g., a username, a customer number, or another type of identifier) for some or all of the customers enrolled with the payment system. The account data 162 can also include one or more account identifiers associated with each customer identifier. The account identifiers associated with the customer identifier of a particular customer correspond to the accounts with a biller 102 that the customer is authorized to access through the service portal 110 of that biller 102. The accounts that are associated with a single customer identifier are sometimes referred to as linked accounts. For instance, when the customer 104a logs in at the service portal 110a of the Atlantic Energy Company 102a, identifiers of the customer's electric and gas accounts with the Atlantic Energy Company are associated with the identifier of the customer 104a.

In some examples, the customer 104 can specify the accounts that are to be linked in the account database 160. For instance, the customer 104 can provide an account number or another type of account identifier for one or more of the accounts he has with a particular biller 102. In some examples, linked accounts are identified automatically. For instance, the access module 154 can automatically link accounts whose owners share a common name, social security number, address, or other feature, or a combination of any two or more of them.

When the access module 154 identifies the linked accounts that are associated with the customer 104, access data 164 (e.g., one or more cookies) indicative of the linked accounts are sent to the customer 104′s computing device 112 (shown for the customer 104a). For instance, the access data 164 can include an identifier of each of the linked accounts. The access data 164 act as credentials that log the customer 104 in to the linked accounts on both the service portal 110 and the payment portal 150. That is, the access data 164 allows the customer 104 to log in to the service portal 110 and gain access to account maintenance services (e.g., through the service portal 110) and payment services (e.g., through the payment portal 150) for all of his linked accounts without having to log in multiple times.

For instance, in one example, the customer 104b of the City of Boston 102b can enter login information 114 at the City of Boston service portal 110b. The customer 104b is authenticated and the customer 104b's linked accounts (e.g., the customer 104b's water account, real estate tax account, and motor vehicle excise tax account) are identified. Access data 164 indicative of those linked accounts are sent to the customer 104b's computing device 112b, thus enabling the customer 104b to access account maintenance services for all of the linked accounts through the service portal 110b and to access payment services for all of the linked accounts through the payment portal 150b.

The payment-related services through the payment portals 150 are managed by the payment system 100, which provides individualized billing services on behalf of multiple independent, unrelated billers 102a, 102b. For instance, the payment system 100 can present invoices to and process payments from customers 104 of multiple billers 102. Invoice data 120 and payment data 122 for each biller 102a, 102b are maintained in an invoice database 124 hosted by the server 152 of the payment system 100. Invoice data 120 for a particular biller 102 can include, for each customer 104 of the biller, an amount due, a due date, an invoice number, and an account number for each type of invoice (we sometimes use the word invoice interchangeably with bill) issued by the biller. Payment data 122 for a particular biller can include records of payments toward each invoice of each customer, including, for each payment, the amount and date of the payment and the account number or invoice number to which the payment was applied. The total of the payments included in the payment data 110 is credited to the biller's account. Further details about the payment system 100 can be found in U.S. patent application Ser. No. 13/890,792, filed May 9, 2013, the contents of which are incorporated here by reference in their entirety.

Through a biller portal 114 of the payment system 100, each biller 102 can independently control the payment experience of its own customers 104. By experience, we mean broadly, for example, the simplicity or complexity, richness of features, speed, accuracy, privacy, and other features of the portal that contribute to the look and feel of the portal and the process of using it.

For instance, through the biller portal 114, each biller 102 can specify whether and how to integrate its own payment portal 150 into its own service portal 110. In some examples, e.g., when the payment portal 150 is distinct from the service portal 110 (e.g., when the payment portal 150 is presented as a separate web site), each biller 102 can specify features for its own payment portal 150 such as, e.g., the name of the biller, a logo or motto of the biller, an address or phone number of the biller, colors associated with the biller, other features specific to the biller, or a combination of any two or more of these features.

Each biller 102 can also use the biller portal 114 to set business rules related to customer payments, customer communications, payment processing, or other features, or a combination of any two or more of them. By business rules, we mean broadly, for example, any principles, guidelines, procedures, or other aspects of how an entity conducts or intends to conduct its operations internally and its relationships with other parties. Business rules can include, e.g., whether partial payments or overpayments are allowed, whether a payment for an invoice can be split among multiple payment methods, when a late fee is to be charged, or other business rules. In some examples, a biller sets common business rules for all types of invoices; in some examples, each type of invoice can have its own set of business rules.

When a biller (e.g., the biller 102a) issues invoices, an invoice file 128 is uploaded from a computing device associated with the biller (e.g., the server 108a or another server) to the payment system 100. The invoice file 128 is stored in the invoice database 124. For each invoice, the invoice file 128 can include information about, e.g., the type of invoice (e.g., an electric bill), the amount due on the invoice, the due date of the invoice, the customer of the invoice (e.g., a name, address, customer identifier, or a combination of any two or more of them), an invoice number, an account number, or other information about the invoice, or a combination of any two or more of them.

Customers (e.g., customer 102a) who are enrolled in paperless billing through the payment system 100 receive an email 130 from the payment system 100 alerting them that an invoice has been issued by the biller 102. The customer 102b can select a link in the email to view the invoice in the payment portal 150b. Customers not enrolled in paperless billing receive a paper invoice mailed to them from or on behalf of the biller and may also receive email alerts. The paper invoice can include instructions for how to view the invoice on the payment system 100, how to enroll in paperless billing, or both.

Through the payment portal 150, the customer 104 can view the invoice, pay the invoice, or both. A customer may be presented with several payment options for paying the invoice, depending on the business rules established by the biller issuing the invoice. For instance, the customer may be able to pay the entire amount due on the invoice immediately, make a partial payment immediately, or schedule one or more future payments.

A variety of payment methods can be available to customers. Customers (e.g., customer 102b) can pay through an online bill pay service provided through a bank 132 (which we refer to here as “online bank direct payments”). Customers (e.g., customer 102b) can pay directly to the biller 102 using a paper check 134 or cash, e.g., by mail or in person at a payment window. Customers (e.g., customer 102a) can also pay through the payment system 100 using the payment interface 150, e.g., by providing credit card, debit card, or bank account information 136 (e.g., for automated clearing house (ACH) payments).

Payment data 122 for each biller is synchronized between the electronic invoice and payment system 100 and the biller's server 108. For instance, a payment file 138 reflecting payments made directly to the payment system 100 by customers of the biller 102a can be provided to the biller system 109a. A payment file 140 reflecting payments made directly to the biller 102a can be provided from the biller system 109b to the payment system 100. Frequent synchronization of payment records enables both the billers 102 and the payment system 100 to maintain consistently updated payment data 122. Updated payment data 122 allows, for instance, a customer 104 to access the payment portal 150 to confirm that his account was credited with a paper check payment made directly to a biller 102. Similarly, a biller 102 can see that an online payment has been made (e.g., directly to the payment system 100 or through an online bank direct payment) immediately or soon after the payment is processed.

Referring to FIG. 2, a customer of a biller (in this example, the biller is a property management company) enrolls in the payment system (200) to gain access to online account maintenance services and payment services for his various accounts with the property management company. Enrollment can include creating a username and password, providing personal information, and specifying the accounts for which he wishes to have online access. For instance, the customer may specify that he wants online access to his rent account, parking account, and gym account. In a database associated with the payment system, identifiers of the accounts specified by the customer are linked to an identifier of the customer (202).

Once enrolled, the customer can enter a username and password to log in to a service portal for the property management company (204). The customer is authenticated (206) based on the username and password and the customer's linked accounts are identified (208). Access data identifying the linked accounts are sent to the customer's computing device (210). The access data acts as a credential that allows the customer to access any of his linked accounts through either the service portal or the payment portal.

Once logged in, the customer can access account maintenance services (212) through the service portal for one or more of his accounts with the property management company. For instance, for the customer's gym account, the customer can start or stop his gym membership, upgrade or downgrade to a different level of gym membership, submit a comment or complaint about gym services or facilities, or access other account maintenance services for the gym account, or a combination of any two or more of them. For the customer's parking account, the customer can cancel his parking account, reserve a parking spot, add a new license plate number or remove an old license plate number, request a replacement parking access card, or access other account maintenance services for the parking account, or a combination of any two or more of them. For the customer's rent account, the customer can specify an end date, create a work order, or access other account maintenance services for the rent account, or a combination of any two or more of them.

The customer can also access payment services (216) through the payment portal for one or more of his accounts with the property management company. For instance, for any of the accounts, the customer can make a payment, schedule a payment, set up an automatic payment schedule, enroll in paperless billing, view invoice or payment history, or access other payment services, or a combination of any two or more of them. In some examples, the property management company can specify different business rules for each account. For instance, the business rules for the rent account may allow the customer to make a partial payment while the business rules for the gym and parking accounts may require only full payments.

Referring to FIGS. 3-11, a series of screenshots shows an example implementation of a service portal and a payment portal for the PowerEnergy utility company. The PowerEnergy utility company offers electric and gas service. Through the PowerEnergy service portal, various account maintenance services are offered. In addition, payment services that are accessible through the PowerEnergy service portal are provided by the payment portal of the payment system.

Referring to FIG. 3, to access his accounts with PowerEnergy, a customer enters his username and password at a login screen 30. In this example, although it appears that the customer is logging in through the PowerEnergy Gas site, the customer's login information is handled by the payment system rather than the biller's server. By logging in, the customer will gain access to all of his accounts with PowerEnergy (e.g., an electric account and a gas account).

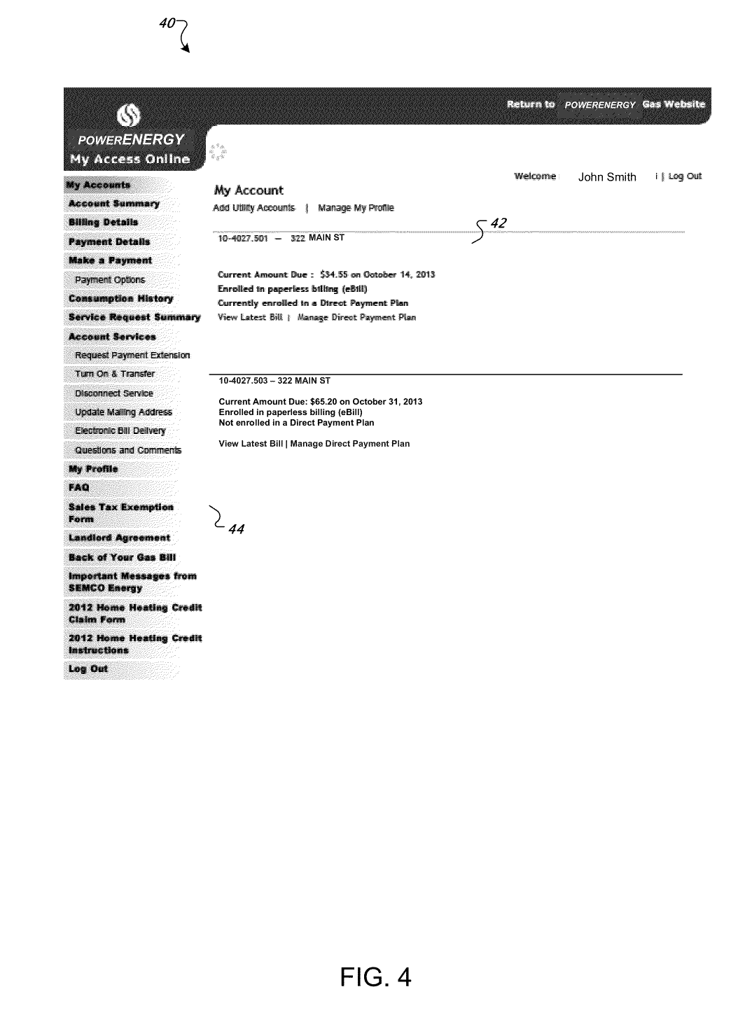

Referring to FIG. 4, an account summary 40 hosted by the PowerEnergy service portal presents a list 42 of the linked accounts to which the customer has access (in this example, an electric account and a gas account). A brief summary of each linked account is provided, e.g., the current amount due on the account, the due date, and any payment notes associated with the account (e.g., whether the account is enrolled in paperless billing, whether automatic payments are enabled, or other payment notes).

A menu 44 lists various services that are accessible through the PowerEnergy service portal. Some of the listed services are account maintenance services that are provided by the PowerEnergy service portal. For instance, for one or more of the linked accounts, the customer can view his consumption history, view a summary of past or current service requests, request a payment extension, turn on service, transfer service, disconnect service, update a mailing address, request electronic bill delivery, and access other account maintenance services, or a combination of any two or more of them. Some of the listed services are payment services that are provided by the payment portal of the payment system. For instance, for one or more of the linked accounts, the customer can view billing details or payment details, make a payment, manage payment options, and access other payment services, or a combination of any two or more of them.

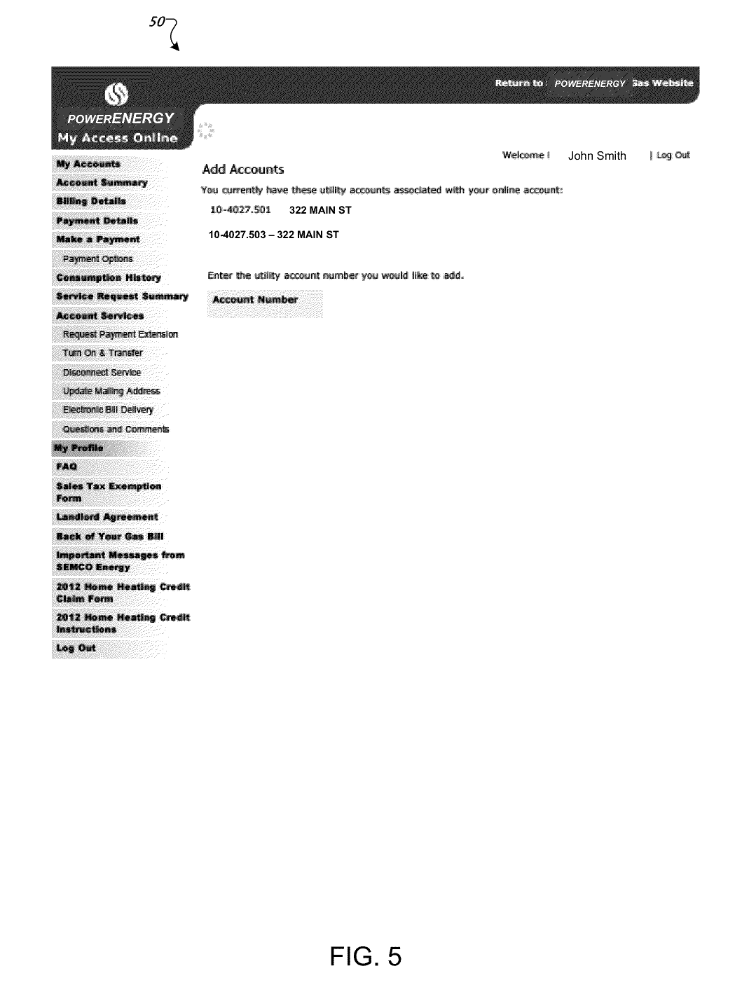

Referring to FIG. 5, the customer can enter an additional linked account (e.g., an electric account for a home business) through an add account screen 50. The customer is prompted to enter the account number of the account to be added. In some cases, the customer may also be prompted to enter additional information to verify that he is associated with the account, such as an address, a phone number, a social security number, or an answer to a security question. The add account screen 50 is administered by the PowerEnergy service portal, but the account number (or other account information) of a newly added account is provided to the payment system to be stored in association with an identifier of the customer, such as an email address of the customer, a customer number associated with the customer, or another unique identifier of the customer.

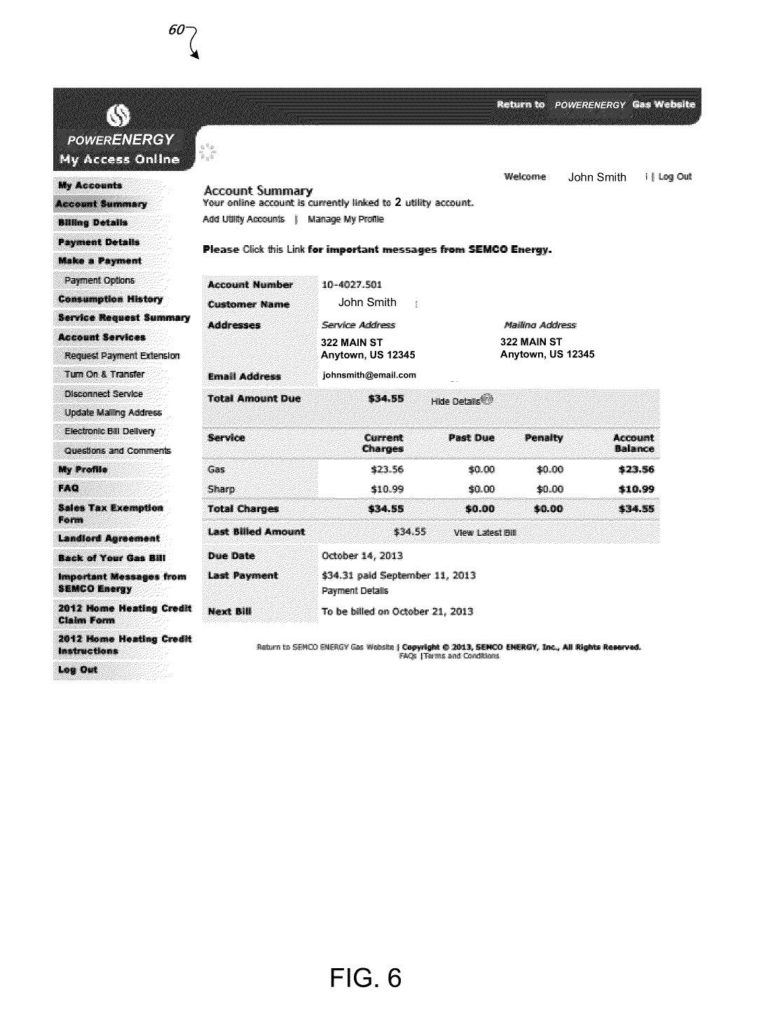

Referring to FIG. 6, for one or more of the linked accounts, the customer can view a detailed account summary 60 provided by the PowerEnergy service portal. The detailed account summary 60 can include information such as, e.g., the account number, contact information associated with the account, current charges on the account, a due date associated with the account, or other information, or a combination of any two or more of them.

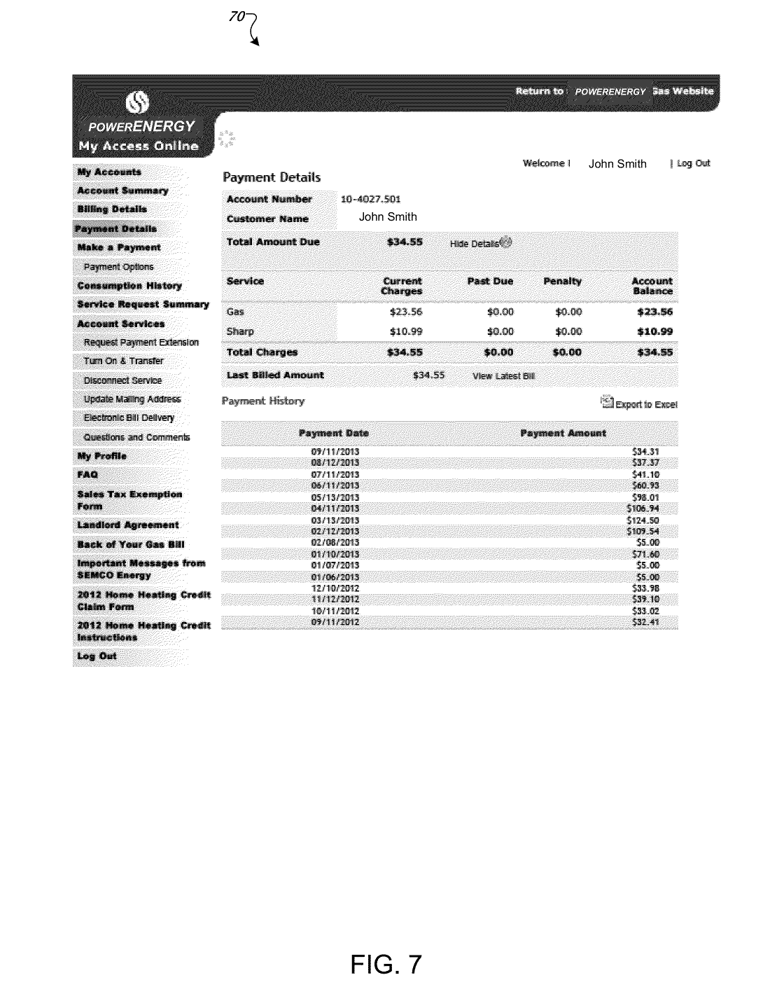

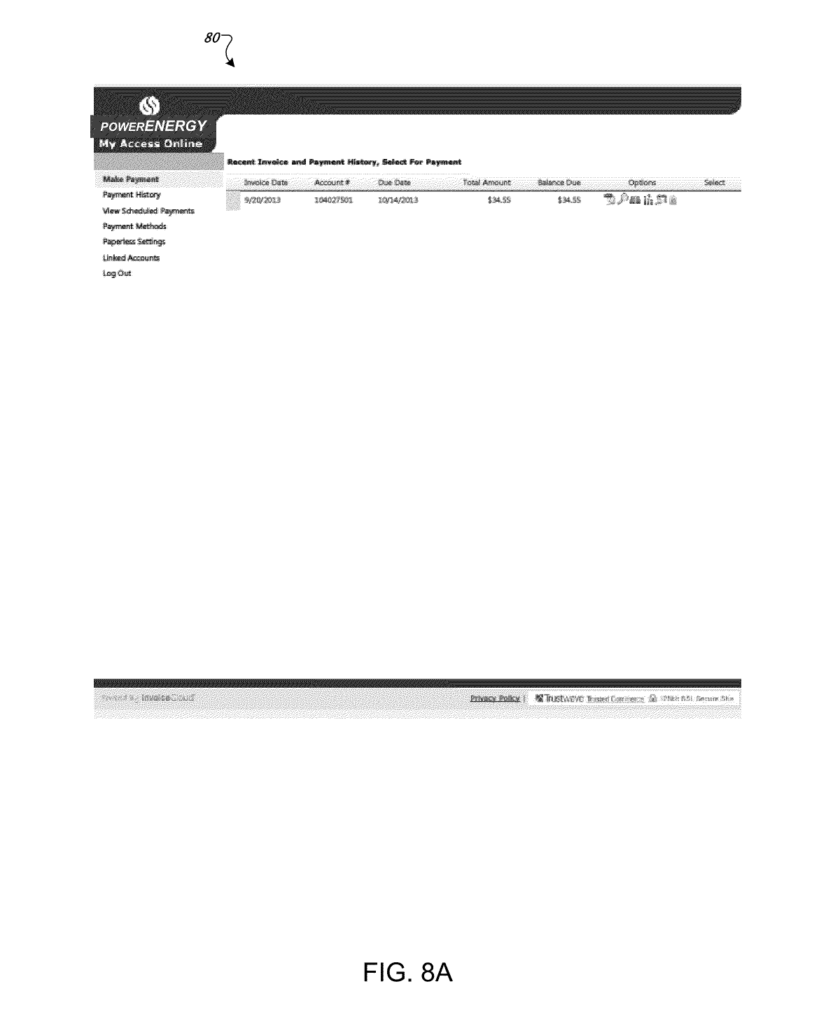

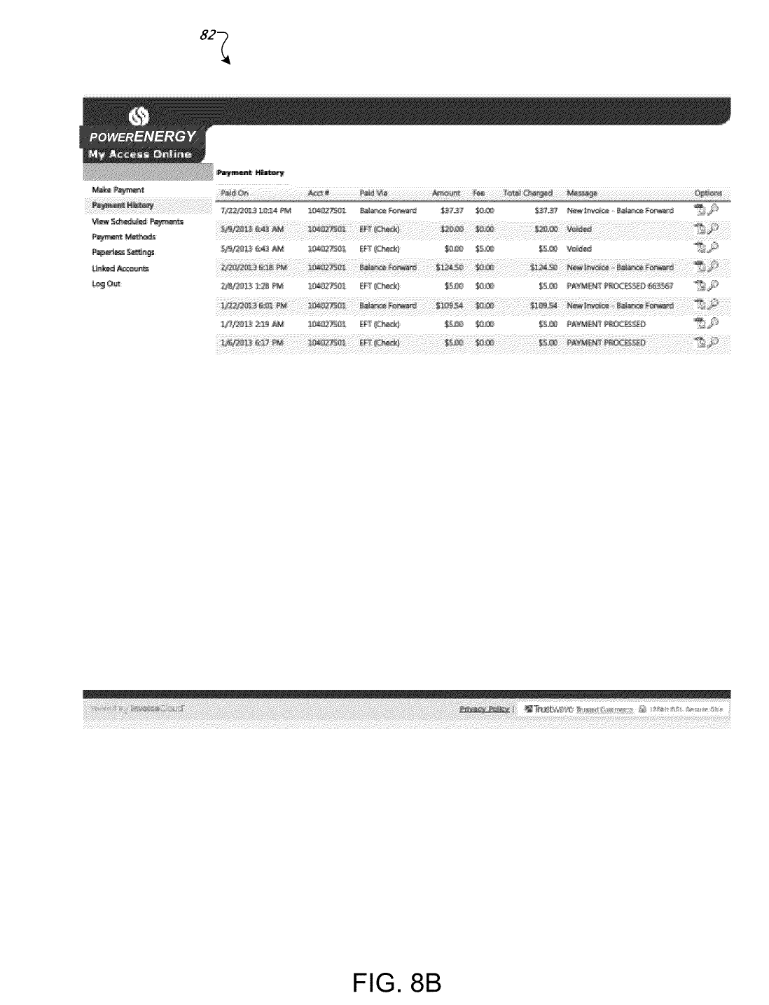

Referring to FIG. 7, for one or more of the linked accounts, the customer can view a payment history 70. The payment history 70 is provided by the PowerEnergy service portal. Referring also to FIGS. 8A and 8B, in some examples, invoice history 80 and payment history 82 can also be available through the payment portal.

The pages for payment services available through the payment portal are branded as if the pages were designed and hosted by the PowerEnergy service portal. For instance, in this example, the PowerEnergy name and logo remain at the upper left corner. In some examples, the pages for payment services are completely integrated into the framework of the service portal such that there is no visual difference between pages for payment services and pages for account maintenance services.

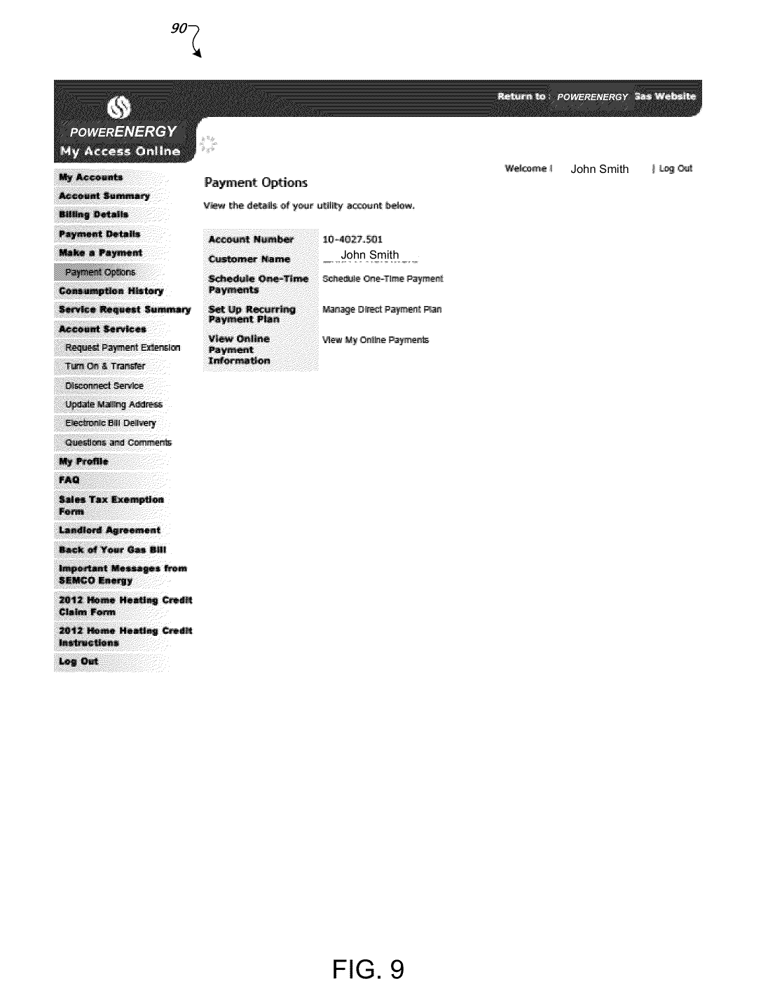

Referring to FIG. 9, the payment system hosts a payment options screen 90 through which the customer can select various options for making a payment to one or more of his PowerEnergy accounts. In the example shown, the customer can schedule a one-time payment or manage a direct payment plan for his gas account. In some examples, other options are also available through the payment options screen, such as the ability to manage an automatic payment plan. In some examples, the available payment options are different for each account, depending on the business rules established by PowerEnergy for each type of account. For instance, an automatic payment plan may be available for electric accounts but not for gas accounts.

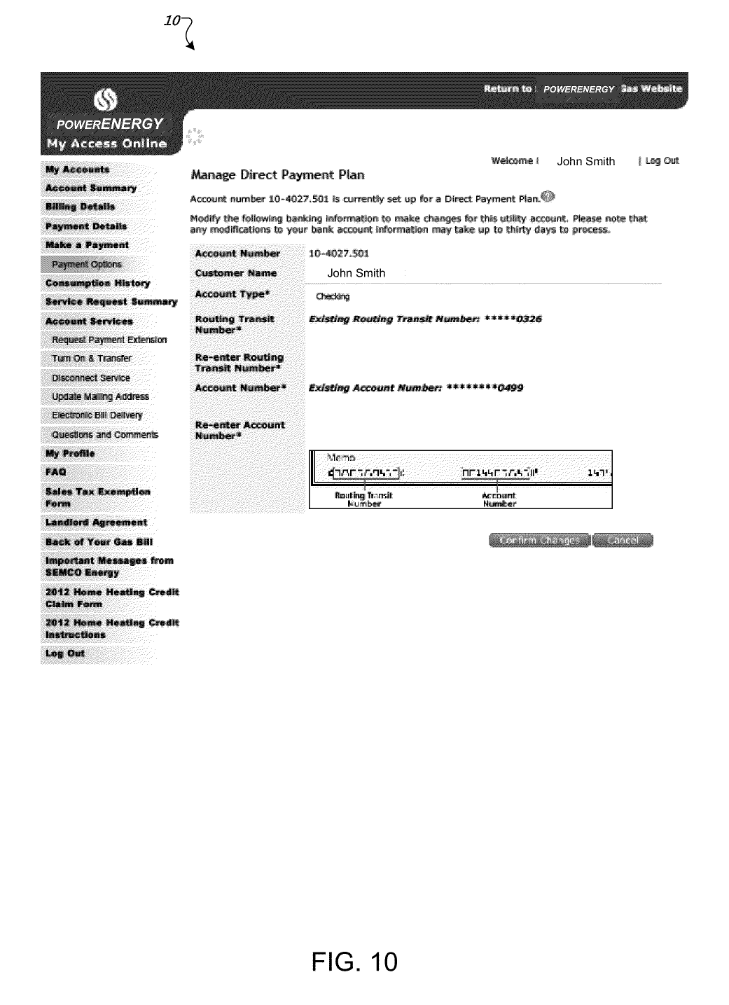

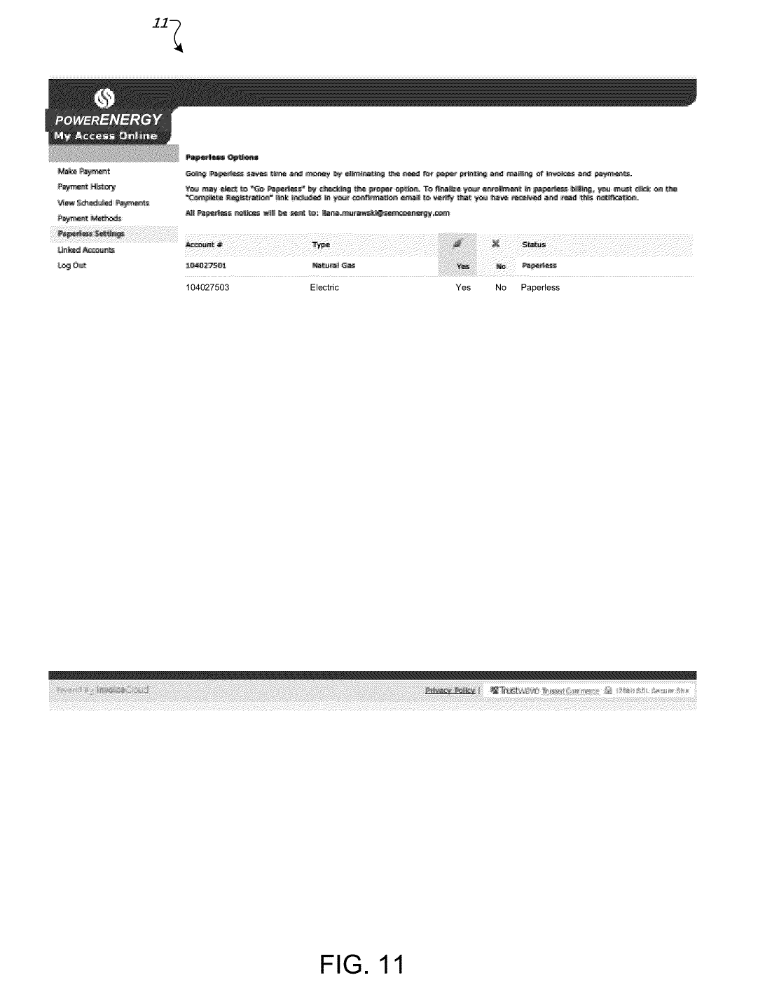

Referring to FIG. 10, in one example, the customer can manage a direct payment plan through a direct payment screen 10. The customer can enter bank details and other information sufficient to enable direct payments to be made from the customer's bank to PowerEnergy. Other payment services can also be available. For instance, referring to FIG. 11, in an enrollment screen 11, the customer can enroll in paperless billing for one or more of the linked accounts.

FIG. 12 shows an example of a personal computing device 1200 and a mobile device 1250, which may be used with the techniques described here. Computing device 1200 is intended to represent various forms of digital computers, such as laptops, desktops, workstations, personal digital assistants, servers, blade servers, mainframes, and other appropriate computers. Computing device 1250 is intended to represent various forms of mobile devices, such as personal digital assistants, cellular telephones, smartphones, wearable computing devices such as glasses or watches, and other similar computing devices. The components shown here, their connections and relationships, and their functions, are meant to be examples only, and are not meant to limit implementations of the techniques described and/or claimed in this document.

Computing device 1200 includes a processor 1202, memory 1204, a storage device 1206, a high-speed interface 1208 connecting to memory 1204 and high-speed expansion ports 1210, and a low speed interface 1212 connecting to low speed bus 1214 and storage device 1206. Each of the components 1202, 1204, 1206, 1208, 1210, and 1212, are interconnected using various busses, and may be mounted on a common motherboard or in other manners as appropriate. The processor 1202 can process instructions for execution within the computing device 1200, including instructions stored in the memory 1204 or on the storage device 1206 to display graphical information for a GUI on an external input/output device, such as display 1216 coupled to high speed interface 1208. In other implementations, multiple processors and/or multiple buses may be used, as appropriate, along with multiple memories and types of memory. Also, multiple computing devices 1200 may be connected, with each device providing portions of the necessary operations (e.g., as a server bank, a group of blade servers, or a multi-processor system).

The memory 1204 stores information within the computing device 1200. In one implementation, the memory 1204 is a volatile memory unit or units. In another implementation, the memory 1204 is a non-volatile memory unit or units. The memory 1204 may also be another form of computer-readable medium, such as a magnetic or optical disk.

The storage device 1206 is capable of providing mass storage for the computing device 1200. In one implementation, the storage device 1206 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1204, the storage device 1206, memory on processor 1202, or a propagated signal.

The high speed controller 1208 manages bandwidth-intensive operations for the computing device 1200, while the low speed controller 1212 manages lower bandwidth-intensive operations. Such allocation of functions is an example only. In one implementation, the high-speed controller 1208 is coupled to memory 1204, display 1216 (e.g., through a graphics processor or accelerator), and to high-speed expansion ports 1210, which may accept various expansion cards (not shown). In the implementation, low-speed controller 1212 is coupled to storage device 1206 and low-speed expansion port 1214. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1200 may be implemented in a number of different forms, as shown in the figure. For example, it may be implemented as a standard server 1220, or multiple times in a group of such servers. It may also be implemented as part of a rack server system 1224. In addition, it may be implemented in a personal computer such as a laptop computer 1222. Alternatively, components from computing device 1200 may be combined with other components in a mobile device (not shown), such as device 1250. Each of such devices may contain one or more of computing device 1200, 1250, and an entire system may be made up of multiple computing devices 1200, 1250 communicating with each other.

Computing device 1250 includes a processor 1252, memory 1264, an input/output device such as a display 1254, a communication interface 1266, and a transceiver 1268, among other components. The device 1250 may also be provided with a storage device, such as a microdrive or other device, to provide additional storage. Each of the components 1250, 1252, 1264, 1254, 1266, and 1268, are interconnected using various buses, and several of the components may be mounted on a common motherboard or in other manners as appropriate.

The processor 1252 can execute instructions within the computing device 1250, including instructions stored in the memory 1264. The processor may be implemented as a chipset of chips that include separate and multiple analog and digital processors. The processor may provide, for example, for coordination of the other components of the device 1250, such as control of user interfaces, applications run by device 1250, and wireless communication by device 1250.

Processor 1252 may communicate with a user through control interface 1258 and display interface 1256 coupled to a display 1254. The display 1254 may be, for example, a TFT LCD (Thin-Film-Transistor Liquid Crystal Display) or an OLED (Organic Light Emitting Diode) display, or other appropriate display technology. The display interface 1256 may comprise appropriate circuitry for driving the display 1254 to present graphical and other information to a user. The control interface 1258 may receive commands from a user and convert them for submission to the processor 1252. In addition, an external interface 1262 may be provided to communicate with processor 1252, so as to enable near area communication of device 1250 with other devices. External interface 1262 may provide, for example, for wired communication in some implementations, or for wireless communication in other implementations, and multiple interfaces may also be used.

The memory 1264 stores information within the computing device 1250. The memory 1264 can be implemented as one or more of a computer-readable medium or media, a volatile memory unit or units, or a non-volatile memory unit or units. Expansion memory 1274 may also be provided and connected to device 1250 through expansion interface 1272, which may include, for example, a SIMM (Single In Line Memory Module) card interface. Such expansion memory 1274 may provide extra storage space for device 1250, or may also store applications or other information for device 1250. Specifically, expansion memory 1274 may include instructions to carry out or supplement the processes described above, and may include secure information also. Thus, for example, expansion memory 1274 may be provide as a security module for device 1250, and may be programmed with instructions that permit secure use of device 1250. In addition, secure applications may be provided through the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1264, expansion memory 1274, memory on processor 1252, or a propagated signal that may be received, for example, over transceiver 1268 or external interface 1262.

Device 1250 may communicate wirelessly through communication interface 1266, which may include digital signal processing circuitry where necessary. Communication interface 1266 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1268. In addition, short-range communication may occur, such as using a Bluetooth, WiFi, or other such transceiver (not shown). In addition, GPS (Global Positioning System) receiver module 1270 may provide additional navigation- and location-related wireless data to device 1250, which may be used as appropriate by applications running on device 1250.

Device 1250 may also communicate audibly using audio codec 1260, which may receive spoken information from a user and convert it to usable digital information. Audio codec 1260 may likewise generate audible sound for a user, such as through a speaker, e.g., in a handset of device 1250. Such sound may include sound from voice telephone calls, may include recorded sound (e.g., voice messages, music files, and so forth) and may also include sound generated by applications operating on device 1250.

The computing device 1250 may be implemented in a number of different forms, as shown in the figure. For example, it may be implemented as a cellular telephone 1280. It may also be implemented as part of a smartphone 1282, personal digital assistant, tablet computer, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used here, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback). Input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Other implementations are also within the scope of the following claims.

What is claimed is:

1. A method comprising:
authenticating one or more customers of each of multiple billers based on information received from each customer;
identifying one or more accounts of each customer, the identified accounts of each customer provided by the biller for the customer; and
enabling each authenticated customer to interact with (i) a biller system associated with the biller for the customer, the biller system providing a first type of service for the identified accounts of the customer, and (ii) a payment system associated with the multiple billers, the payment system providing a second type of service for the identified accounts of the customer.

2. The method of claim 1, in which enabling an authenticated customer to interact with the payment system comprises providing a site associated with the payment system for display to the customer.

3. The method of claim 2, in which providing a site associated with the payment system for display to the customer includes providing the site associated with the payment system for display within a site associated with the biller system for the customer.

4. The method of claim 1, in which enabling an authenticated customer to interact with the biller system and the payment system comprises enabling the customer to access information about one or more of the identified accounts of the customer through the biller system, the payment system, or both.

5. The method of claim 1, in which enabling an authenticated customer to interact with the biller system and the payment system comprises enabling the customer to take an action associated with one or more of the identified accounts of the customer through the biller system, the payment system, or both.

6. The method of claim 1, in which the biller system provides account maintenance services.

7. The method of claim 6, in which account maintenance services comprise one or more of creating a work order, transferring a service, starting a service, stopping a service, and changing a contact information.

8. The method of claim 1, in which the payment system provides payment services.

9. The method of claim 8, in which payment services comprise one or more of making a payment, scheduling a payment, setting up an automatic payment schedule, and enrolling in paperless billing.

10. The method of claim 1, in which authenticating a particular customer comprises: receiving information from the particular customer; and comparing the received information to stored information for multiple customers.

11. The method of claim 10, in which the received information includes a customer identifier and a password.

12. The method of claim 1, in which identifying one or more accounts for a particular customer comprises retrieving, from a database, one or more account identifiers associated with an identifier of the particular customer.

13. The method of claim 1, in which the biller system is associated with fewer than all of the multiple billers.

14. The method of claim 13, in which the biller system is associated with only the biller.

15. The method of claim 1, in which enabling each authenticated customer to interact with the biller system and the payment system comprises providing access data to each authenticated customer.

16. The method of claim 15, in which the access data for each customer includes an identifier of each of the one or more accounts of the customer.

17. The method of claim 1, comprising enabling each biller to specify one or more rules associated with an interaction between a customer of the biller and the payment system.

18. The method of claim 17, in which the one or more rules include rules associated with an appearance of a site of the payment system.

19. The method of claim 17, in which the one or more rules include a rule that indicates a relationship between a site of the payment system and a site of the biller system associated with the biller.

20. The method of claim 19, in which the relationship includes a position of the site of the payment system within the site of the biller system.

21. The method of claim 17, in which the one or more rules include a rule indicative of a payment activity that is permitted, a rule indicative of a payment activity that is prohibited, or both.

22. A computer readable medium storing instructions for causing a computing device to:
authenticate one or more customers of each of multiple billers based on information received from each customer;
identify one or more accounts of each customer, the identified accounts of each customer provided by the biller for the customer; and
enable each authenticated customer to interact with (i) a biller system associated with the biller for the customer, the biller system providing a first type of service for the identified accounts of the customer, and (ii) a payment system associated with the multiple billers, the payment system providing a second type of service for the identified accounts of the customer

23. A method comprising:
for each of multiple billers:
serving, by a first computing device associated with the multiple billers, a payment site for one or more accounts of a customer of the biller,
the payment site to be presented to the customer in association with a service site for the one or more accounts of the customer, the service site served by a second computing device associated with the biller.

24. The method of claim 23, in which the payment site is to be presented within a frame provided by the service site.

25. The method of claim 23, comprising authenticating the customer of the biller.

26. The method of claim 25, in which authenticating the customer of the biller enables the customer to access the payment site and the service site.

27. The method of claim 23, in which the payment site provides payment services for the one or more accounts of the customer.

28. The method of claim 23, in which the service site provides account maintenance services for the one or more accounts of the customer.

29. A computer readable medium storing instructions for causing a computing system to:
for each of multiple billers:
serve, by a first computing device associated with the multiple billers, a payment site for one or more accounts of a customer of the biller,
the payment site to be presented to the customer in association with a service site for the one or more accounts of the customer, the service site served by a second computing device associated with the biller.
